(19) United States
(12) Patent Application Publication
(10) Pub. No.: US 2010/0034948 A1
(43) Pub. Date: Feb. 11, 2010

(54) Method of Making a Fruit Spread and Fruit Spread Composition

(76) Inventor: Frederick Clifton Ross, New Vernon, NJ (US)

Correspondence Address: WOLFF & SAMSON, P.C., ONE BOLAND DRIVE, WEST ORANGE, NJ, 07052, US

(21) Appl. No.: 12/496,319

(22) Filed: Jul. 1, 2009

Related U.S. Application Data
(60) Provisional application No. 61/133,680, filed on Jul. 1, 2008.

(51) Int. Cl. A23L 1/064; A23L 1/068; A23L 1/0524

(52) U.S. Cl. 426/577

(57) ABSTRACT

A method of making a fruit spread is provided that includes adding a first quantity of a particular fruit to a vessel, and adding a second quantity of concentrated juice of the particular fruit to the vessel. The method also includes adding a third quantity of another sweetener to the vessel to form a combination with the first and second quantities, and removing at least some of the water from the combination. A fruit spread made by the method is provided. A fruit spread is provided that includes first soluble solids from a particular fruit and second soluble solids a concentrated juice of the particular fruit. In the fruit spread, the first and second soluble solids represent between 5 and 99 percent by weight of an initial total soluble solids of the fruit spread.

### CROSS-REFERENCE TO RELATED APPLICATIONS

This application claims the benefit of U.S. Provisional Application No. 61/133,680 filed Jul. 1, 2008, which is incorporated herein by reference.

### FIELD OF THE INVENTION

The present invention relates to jams, jellies, preserves, fruit spreads and spreadable fruit. In particular, the present invention relates to a method of making a fruit spread and a fruit spread made by the method.

### BACKGROUND OF THE INVENTION

The present invention relates to jam, jelly, preserves, fruit spread and spreadable fruit. Historically, fruit (for example strawberries or apricots) was preserved so that it could be eaten year round, not just seasonally. In order to do this, the fruit was cooked in sugar or high fructose or regular corn syrup at a ratio of about 45 initial weight % fruit (i.e. strawberries) and 55 initial weight % sweetener, such as sugar, high fructose corn syrup, etc.

Subsequently, fruit juice concentrates were used by some products to replace the sugar or corn syrup. White grape juice concentrate, pear juice concentrate, or any other fruit concentrate other than made from the named fruit flavor, or a combination thereof may be used as the sweetener in these products, which are generally called 100% Fruit or All Fruit spreadable fruits. These sweeteners may be chosen because they have little impact on the flavor of the spread. Using fruit juice concentrates, 40-50 initial weight % of the fruit may be combined with 50-60 initial weight % of white grape, pear or apple concentrate. Since both the sweetener and the fruit are actually fruit, it is possible to market this product as 100% fruit. These percentages are calculated based on the weight of single strength unconcentrated fruit combined with concentrates that are concentrated between 700% to 850%. For example, combining 45 pounds of strawberries with 55 pounds of white grape juice concentrate, it takes 7 to 9 times that amount of grape juice, i.e. 385 pounds, to make 55 pounds of white grape juice concentrate.

Strawberries may be 8% solids and 92% water, and grapes, pears or apples when squeezed may have a juice that ranges between 8% and 10% solids and between 90% and 92% water. When grape juice is concentrated, it may take 8 or more pounds of grape juice to make 1 pound of grape juice concentrate. A typical method for making an “all fruit” spreadable fruit may use 8 pounds of grape juice turned into 1 pound of grape juice concentrate, mixed with 1 pound of unconcentrated strawberries. Thus, an all fruit spreadable fruit made by this conventional method may be produced from 1/9 strawberries and 8/9 grapes, as measured by weight of the original fruit. In the case of standardized jams, jellies or preserves, the final product is produced from 8/9 unconcentrated cane juice, concentrated into sugar (or the equivalent from corn, high fructose corn, sugar beat juice, etc.).

In an alternative example, 50 pounds of strawberries and 50 pounds of white grape juice concentrate may be combined to make an all fruit spread. The 50 pounds of white grape juice concentrate requires 350 pounds of grape juice to produce. The grape juice to produce may have 68% solids initially, or 34 pounds. The strawberries may have 4 pounds of soluble solids, and therefore the final product will have 38 pounds of soluble solids. If the final product is a jam having 66% soluble solids, then the weight of the final product will be 58 pounds. This final product will have, though made with 50% strawberries as measured by weight compared to the grape juice concentrate, only 6.9% strawberry solids. The final product will have 60% white grape solids.

The biggest failing in preserves, jams, fruit spreads, etc. today is that each has only a relatively small amount of the fruit by which the product is named. Consumers buying, for example, strawberry jam or fruit spread, do not realize that the product they are purchasing in fact contains very little of the fruit, i.e. strawberry, named on the label. Applicant is not aware of any forms of this type of jams or fruit spreads made mostly from the “named” fruit (also referred to herein as the particular fruit) by which the product is called, i.e. “strawberry” jam.

### SUMMARY OF THE INVENTION

The instant invention provides the significant benefits of increasing the soluble solids in a fruit spread which are derived from the particular fruit designated from the fruit spread. This is achieved by adding concentrated fruit juice of the particular fruit to the batch along with other sweetener, before evaporating or otherwise removing water from the combination.

A method of making a fruit spread is provided that includes, among other things, adding a first quantity of a particular fruit to a vessel, and adding a second quantity of concentrated juice of the particular fruit to the vessel. The method also includes adding a third quantity of another sweetener to the vessel to form a combination with the first and second quantities, and removing at least some of the water from the combination.

In the method, when the particular fruit has 7% or greater of soluble solids in a naturally occurring form, a percentage by weight of the fruit spread of soluble solids from the particular fruit in the first and second quantities may be between 9 and 72 percent. When the particular fruit has 10% or greater of soluble solids in the naturally occurring form, the percentage by weight in the fruit spread of soluble solids from the particular fruit in the first and second quantities may be between 11 and 68 percent. When the particular fruit has 12% or greater of soluble solids in the naturally occurring form, the percentage by weight in the fruit spread of soluble solids from the particular fruit in the first and second quantities may be between 13 and 68 percent.

In the method, a percentage by weight of soluble solids in the fruit spread from the particular fruit in the first and second quantities may be between 5 and 100 percent, or more narrowly, between 15 and 75 percent by weight.

In the method, the fruit spread includes soluble solids of between 15 and 72 percent by weight, or more narrowly, between 30 and 66 percent by weight. Alternatively, the fruit spread includes soluble solids of greater than 24 percent by weight.

In the method, the other sweetener may be a second concentrated juice of a second fruit, and the third quantity may represent between 1 and 99 percent by weight of a sub-combination of the second and third quantities. The first quantity may represent between 0 and 60 percent by weight of a total of the first, second and third quantities, or more narrowly, may represent approximately 45 percent by weight of the total. The second quantity may represent between 5 and 55 percent by weight of the total, and the third quantity may represent between 0 and 50 percent of the total. The second quantity may represents approximately 10 percent by weight of the total, and the third quantity may represent approximately 45 percent by weight of the total.

The method may include pasteurizing the combination to form the fruit spread. The particular fruit may be strawberry, apricots, blueberries, grape, boysenberry, orange, blackberry, black raspberry, peach, or raspberry.

A fruit spread made by the method is provided. A fruit spread is provided that includes first soluble solids from a particular fruit and second soluble solids a concentrated juice of the particular fruit. In the fruit spread, the first and second soluble solids represent between 5 and 99 percent by weight of a total soluble solids of the fruit spread.

These and other advantages of the invention will be apparent to those of ordinary skill in the art by reference to the following detailed description and the accompanying drawings.

### BRIEF DESCRIPTION OF THE DRAWINGS

FIG. 1 illustrates a method according to an embodiment of the instant invention.

FIG. 2 illustrates schematically a system for making a fruit spread according to an embodiment of the instant invention.

### DETAIL DESCRIPTION

As used in the following, fruit spread includes “all fruit” fruit spreads, jams, jellies, conserves, spreadable fruit, marmalades, and preserves. Sweeteners used in the following examples and claims as “other sweeteners” may be, but are not limited to, any one or more of the following: sugar, sugar syrup, vegetable-based sweetener, corn syrup, high fructose corn syrup, honey, beet sugar syrup, rice syrup (brown or white), molasses, granulated sugar, granulated corn solids, maple syrup grape juice concentrate (red or white), pear juice syrup, apple juice syrup, pineapple juice syrup, any other syrup made from any other fruit, sorbitol, honey, artificial sweeteners, or dietetic products made with or without aspartame, saccharin, etc. as desired for taste. The particular fruit referred to herein may be a fresh fruit, puree (of 2, 3, 4 or more fold strength), crumbled fruit, instant quick frozen (IQF), block frozen, straight pack, broken, chopped, or minced. Any of these forms may be referred to hereinafter as “unprocessed” fruit, to distinguish it from the concentrated fruit juice form.

Additionally, each of the following examples may additionally include the addition of a stabilizer, for instance pectin, starch, arrowroot, gelatin, seaweed, xanthan gum, or clear gel. The stabilizer may be added prior to and/or after the removal of water.

Measurements in the following examples and claims may be in pounds, or alternatively be made in metric units. An initial weight or an initial total may represent a weight or percentage of a total weight of the set or combination of initial ingredients. The soluble solids in a finished product may be expressed as a weight or a percentage of the entire weight of the finished product, including water. The soluble solids derived from a particular, named fruit refers to soluble solids derived from the whole fruit, concentrated juice of the particular fruit, or any other product comprising the particular fruit.

When measured against the amount of that named fruit which is used normally in spreadable fruits, for example, in a strawberry spreadable fruit, the present invention may result in 50% to 800% more strawberries (when measuring the weight of the strawberry solids derived from the strawberries and strawberry concentrate against all other sweeteners used in the product). The present invention provides a finished product made from at least 50% but preferably 100% or several hundred percent more strawberry solids than conventional jams, jellies, preserves, conserves, fruit spreads, spreadable fruits, etc., found on the market today. This may be accomplished by sweetening the fruit using a juice concentrate made from the same fruit. For example, if the fruit is strawberries, the juice concentrate used as a sweetener would be made from strawberries or strawberries and other sweeteners so that many possible configurations of a strawberry product can be obtained, each having far more strawberries in the finished product.

One possible product resulting from the present invention includes strawberry preserves meeting the standard of identity of preserves cooked to 65/66% solids, strawberry jelly or jam. The sweeteners used may be seedless strawberry juice concentrate or syrup alone, or in conjunction with another sweetener, as desired for taste.

Regardless of which additional sweeteners are used, the amount of fruit concentrate of the named fruit, together with the named fruit, may be more than 50% more of the amount of the named fruit than is present in typical products sold in this product category. The final product, when measured without the water (i.e., the soluble solids), will have at least 50% but preferably 100%, 200% or even several hundred percent more soluble solids derived from the named fruit than a conventional all fruit spread. The present invention also makes it possible to produce a product made from nearly 100% strawberries, with 1% or less of fruit pectin as a stabilizer.

Some fruits have greater than 7% or greater of soluble solids in a naturally occurring form, and more particularly, some fruits have greater than 10% or greater of soluble solids in a naturally occurring form. A method according to the instant invention may provide that the percentage by weight in the fruit spread of soluble solids from the particular fruit in the unprocessed form and the concentrated juice may be between 11 and 68 percent. Other fruits may have greater than 12% soluble solids in the naturally occurring form, for instance wild blueberries. In this case, the percentage by weight in the fruit spread of soluble solids from the particular fruit in the first and second quantities may be between 13 and 68 percent.

The method may produce a fruit spread having soluble solids of between 15 and 72 percent by weight, or more particularly, between 40 and 68 percent by weight. Alternatively, the method may produce a fruit spread having soluble solids of greater than 24 percent by weight.

The quantity of other sweetener, when it is a second concentrated juice of a second fruit, may be between 1 and 99 percent by weight of a sub-combination of the second and third quantities.

The quantity of unprocessed fruit may represent between 1 and 60 percent by weight of an initial total of the fruit, fruit juice concentrate, and the other sweetener. More particularly, the quantity of unprocessed fruit may represent between 30 and 50 percent by weight of the initial total, or even more particularly, the quantity of unprocessed fruit may represent between 40 and 50 percent by weight of the initial total, by weight.

The amount of concentrated fruit juice of the particular, named fruit may represent between 1 and 60 percent by weight of the initial total, and the quantity of other sweetener may represent between 1 and 50 percent of the initial total, by weight. More particularly, the quantity of concentrated fruit juice of the particular, named fruit may represent represents between 5 and 25 percent by weight of the initial total, and the quantity of the other sweetener may represent between 30 and 50 percent by weight of the initial total.

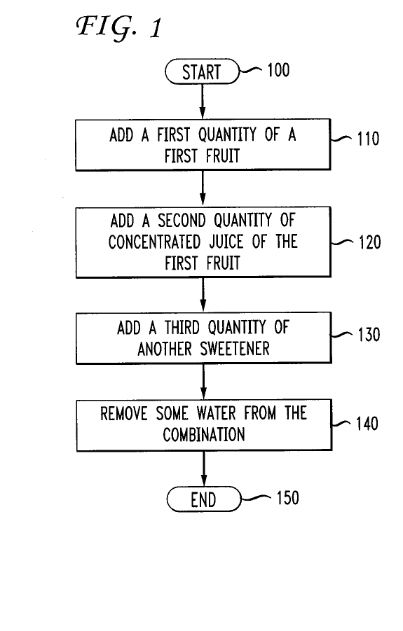

FIG. 1 illustrates the method according to the instant invention. The method starts at start circle 100 and proceeds to operation 110, which indicates to add a first quantity of a first fruit. From operation 110, the flow proceeds to operation 120, which indicates to add a second quantity of concentrated juice of the first fruit. From operation 120, the flow proceeds to operation 130, which indicates to add a third quantity of another sweetener. From operation 130, the flow proceeds to operation 140, which indicates to remove some water from the combination. The water may be removed from the combination by any conventional method, including vacuum pans and/or heating. From operation 140, the flow proceeds to end circle 150.

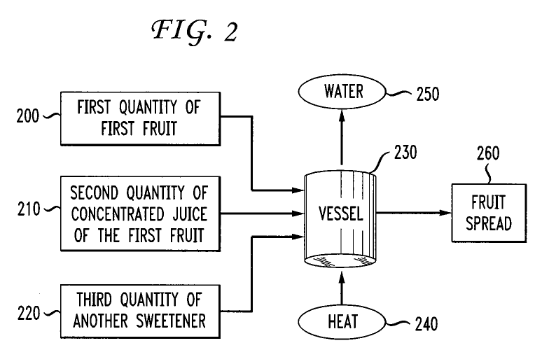

FIG. 2 illustrates schematically a system for performing a method according to the instant invention, and for making a fruit spread according to the instant invention. In FIG. 2, a first quantity of a first fruit 200 is added to a vessel 230. A second quantity of concentrated fruit juice of the first fruit 210 and a third quantity of another sweetener 220 are also added to the vessel 230. Vessel 230 may be a kettle, vacuum pan, or any other appropriate device for removing water. Removing water causes sugar absorption osmosis into the fruit and equalization of solids throughout the product. Vessel 230 is heated by heat 240 in FIG. 3, though alternative arrangement for removing water 250 from vessel 230 are also possible. After water 250 is removed from vessel 230, fruit spread 260 is produced. Fruit spread 260 may be pasteurized by the heating process in vessel 230 or may thereafter be pasteurized and packaged for sale.

A percentage by weight of soluble solids in the fruit spread from the particular fruit in the first and second quantities may be between 5 and 100 percent, and more specifically may be between 35 and 60 percent.

The fruit spread may include soluble solids of between 15 and 72 percent by weight, and more specifically may includes soluble solids of between 50 and 66 percent by weight. The fruit spread may include soluble solids of greater than 24 percent by weight.

The other sweetener may be a second concentrated juice of a second fruit, and the third quantity may represent between 1 and 99 percent by weight of a sub-combination of the second and third quantities.

The first quantity may represent between 0 and 60 percent by weight of a total of the first, second and third quantities, and more specifically, the first quantity may represent approximately 45 percent by weight of the total.

The second quantity may represent between 5 and 55 percent by weight of the total, and the third quantity may represent between 0 and 50 percent of the total. In particular, the second quantity may represent approximately 10 percent by weight of the total, and the third quantity may represent approximately 45 percent by weight of the total.

The particular fruit may be strawberry, apricot, blueberry, grape, boysenberry, orange, blackberry, black raspberry, peach, pineapple, mango, guava, papaya, choke cherry, cherry, lemon, red currant, black currant, or any other appropriate fruit.

The present invention provides a fruit and sweetener based product that may contain 55% by initial weight of the particular fruit listed on the label of the product. The present invention may also provide at least 50% more of the particular fruit that is listed on the label of the product compared to standard jams, jellies, preserves, fruit spread and spreadable fruits. In particular, a fruit spread according to the instant invention may provide up to 700% to potentially 900% more fruit solids of the named fruit than conventional fruit spreads, jams, jellies, or preserves.

The present invention makes it possible to provide a fruit spread, jam, jelly, preserve that is actually made up of at least a majority of the fruit that is used in the name of the product. For example, an apricot jam using apricot juice concentrate would contain more than 51 initial weight percentage of apricots, in contrast to conventional apricot jams.

In one example, a strawberry jam/fruit spread is made using 1 pound of strawberry concentrate, which is itself made from 9 pounds of strawberries. The final product may be made by cooking 1 pound of whole strawberries in the strawberry concentrate. In this case the entire soluble solids of the final product are derived from strawberries.

In another example, a strawberry jam/fruit spread made as recited shown in the previous example, except the strawberry concentrate is reduced by ⅓ and replaced by grape juice concentrate. The final product in this case would be derived from 7 pounds of strawberries and 3 pounds of grape juice. In contrast, a conventional jam may be made using 45 to 50 pounds of strawberries and 50 to 55 pounds of sugar syrup or other sweetener.

Strawberries have 8% soluble solids. The present invention, on the other hand, uses a strawberry concentrate that is 68% soluble solids, which imparts far more strawberry solids to the final product. A conventional preserve that is 65% solids after cooking may have the following formula:

45 pounds strawberries×8% solids=3.6 pounds strawberry solids and 41.1 pounds of water in the strawberries; and

55 pounds high fructose corn syrup×71% solids=39 pounds of soluble solids and 16 pounds of water in the high fructose corn syrup.

This final conventional product cooked in a vessel (for instance, a vacuum pan or open kettle) to 65% solids will have:
3.6 pounds of strawberry solids;
39 pounds corn solids;
22.4 pounds water; and
65 pounds total finished product (35 pounds of the water is boiled off in the cooking process).

Therefore, this conventional product will have 8.4% of the soluble solids derived from strawberries.

By comparison, the following example (as one of many possible configurations) of the present invention has the following formula:

45 pounds strawberries×8% solids=3.6 pounds strawberry solids and 41.1 pounds of water in the strawberries;

18 pounds strawberry juice concentrate×68% soluble solids=12.2 pounds strawberry solids and 5.8 pounds of water; and

37 pounds high fructose corn syrup×71% solids=26.3 pounds corn solids and 10.7 pounds of water.

The final product in this example, after being cooked (in a vacuum pan or open kettle) to 65% solids has:
15.8 pounds strawberry solids;
26.6 pounds corn solids; and
22.4 pounds water.

Therefore, this product according to the present invention will have 37.2% of the soluble solids derived from strawberries. Note that the 15.8 pounds of strawberry solids of the present invention, compared to the 3.6 pounds of the conventional product is 439% more strawberries.)

In another example, a spread is made of 30 pounds of strawberries, 35 pounds of strawberry juice concentrate (made from 280 pounds of strawberries) and 35 pounds of white grape juice concentrate. These components are mixed together and processed as previously discussed to produce a finished product that has 23 pounds of strawberry solids, 22 pounds of solids from grapes and 45 pounds of water. Therefore, this product may be more than 25% strawberry solids, and may have substantially more strawberries in it than conventional jams, jellies, preserves, fruit spreads, spreadable fruits etc.

Alternatively, if this product was cooked to 65% solids, it could be called a preserve, and the final product would be 33% solids from strawberries compared with 5.5% solids if standard preserve formulas had been used. Therefore, the fruit spread made according to the instant invention may have So our product is 600% more strawberry solids than a conventional fruit spread.

Another exemplary embodiment provides for the use of 5% whole strawberries, 20% strawberry concentrate and 75% sugar syrup or grape juice concentrate, as measured by the initial weight percentage. This embodiment would have four times the strawberries of conventional fruit spreads of preserves, jams or jellies. Another exemplary embodiment provides for using 13% strawberry concentrate and 87% of another sweetener, and no whole strawberries. This formulation would yield 50% more strawberry solids than conventional products.

As a comparison, conventional all fruit strawberry spreads may be made approximately with 40 pounds of strawberries and 60 pounds of white grape juice concentrate so that the finished product has 3.2 pounds of strawberry solids, 42 pounds of solids from grape juice and 45 pounds of water. As can be seen, the fruit spread of the present invention contains seven times more strawberries than fruit spreads of the prior art.

Alternative examples may use apricots with concentrated apricot juice or apples with concentrated apple juice. Some exemplary embodiments may use a maximum of 40% initial weight of the named fruit and 31% concentrate of the named fruit, along with 29% of a second sweetener. This sample formulation may provide 600 or 700% more of the named fruit solids than conventional jams and preserves.

In another example, 50 pounds of raspberry juice concentrate at 68% solids is mixed with 30 pounds of whole raspberries. The mixture is pumped into a vacuum pan and boiled at 135 degrees Fahrenheit for 15 minutes or until the product reaches anywhere between 30% and 68% solids, depending on the final characteristics desired. Then the mixture is pumped to a pasteurization kettle and the temperature is raised to 190 degrees Fahrenheit and subsequently pumped to a filler machine. The product is filled into a container and the container is capped using steam injection (or by flipping the containers upside down for 3.5 minutes). The product is held for 3.5 minutes and then the bottles are conveyed through a bottle washer and cooling tunnel until the temperature is below 120°. This finished product, whether 30% solids or 68% solids, is made from 100% raspberries or no less than 99% if small amounts of fruit pectin are needed to create the desired texture.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention.

We claim:

1. A method of making a fruit spread, comprising:
adding a first quantity of a particular fruit to a vessel;
adding a second quantity of concentrated juice of the particular fruit to the vessel;
adding a third quantity of another sweetener to the vessel to form a combination with the first and second quantities; and
removing at least some of the water from the combination.

2. The method of claim 1, wherein:
the particular fruit has 7% or greater of soluble solids in a naturally occurring form; and
a percentage by weight of the fruit spread of soluble solids from the particular fruit in the first and second quantities is between 9 and 72 percent.

3. The method of claim 2, wherein:
the particular fruit has 10% or greater of soluble solids in the naturally occurring form; and
the percentage by weight in the fruit spread of soluble solids from the particular fruit in the first and second quantities is between 11 and 68 percent.

4. The method of claim 3, wherein:
the particular fruit has 12% or greater of soluble solids in the naturally occurring form; and
the percentage by weight in the fruit spread of soluble solids from the particular fruit in the first and second quantities is between 13 and 68 percent.

5. The method of claim 1, wherein the fruit spread includes soluble solids of between 15 and 72 percent by weight.

6. The method of claim 5, wherein the fruit spread includes soluble solids of between 40 and 68 percent by weight.

7. The method of claim 1, wherein the fruit spread includes soluble solids of greater than 24 percent by weight.

8. The method of claim 1, further comprising pasteurizing the combination to form the fruit spread.

9. The method of claim 1, wherein:
the other sweetener is a second concentrated juice of a second fruit; and
the third quantity represents between 1 and 99 percent by weight of a sub-combination of the second and third quantities.

10. The method of claim 1, wherein the first quantity represents between 1 and 60 percent by weight of an initial total of the first, second and third quantities.

11. The method of claim 10, wherein the first quantity represents between 30 and 50 percent by weight of the initial total.

12. The method of claim 11, wherein the first quantity represents between 40 and 50 percent by weight of the initial total.

13. The method of claim 10, wherein:
the second quantity represents between 1 and 60 percent by weight of the initial total; and
the third quantity represents between 1 and 50 percent of the initial total.

14. The method of claim 13, wherein:
the second quantity represents between 5 and 25 percent by weight of the initial total; and
the third quantity represents between 30 and 50 percent by weight of the initial total.

15. The method of claim 1, wherein the particular fruit is one of strawberry, apricot, blueberry, grape, boysenberry, orange, blackberry, black raspberry, peach, pineapple, mango, guava, papaya, choke cherry, cherry, lemon, red currant, and black currant.

16. A fruit spread made by a method, the method comprising:
adding a first quantity of a particular fruit to a vessel;
adding a second quantity of concentrated juice of the particular fruit to the vessel;
adding a third quantity of another sweetener to the vessel to form a combination with the first and second quantities; and
removing at least some of the water from the combination.

17. The fruit spread of claim 16, wherein a percentage by weight of the fruit spread of soluble solids from the particular fruit in the first and second quantities is between 9 and 72 percent.

18. The fruit spread of claim 17, wherein:
the particular fruit has 10% or greater of soluble solids in a naturally occurring form; and
the percentage by weight in the fruit spread of soluble solids from the particular fruit in the first and second quantities is between 11 and 68 percent.

19. The fruit spread of claim 18, wherein:
the particular fruit has 12% or greater of soluble solids in the naturally occurring form; and
the percentage by weight in the fruit spread of soluble solids from the particular fruit in the first and second quantities is between 13 and 68 percent.

20. The fruit spread of claim 16, wherein the fruit spread includes soluble solids of between 15 and 72 percent by weight.

21. The fruit spread of claim 20, wherein the fruit spread includes soluble solids of between 40 and 68 percent by weight.

22. The fruit spread of claim 16, wherein the fruit spread includes soluble solids of greater than 24 percent by weight.

23. The fruit spread of claim 16, the method further comprising pasteurizing the combination to form the fruit spread.

24. The fruit spread of claim 16, wherein:
the other sweetener is a second concentrated juice of a second fruit; and
the third quantity represents between 1 and 99 percent by weight of a sub-combination of the second and third quantities.

25. The fruit spread of claim 16, wherein the first quantity represents between 1 and 60 percent by weight of an initial total of the first, second and third quantities.

26. The fruit spread of claim 25, wherein the first quantity represents between 30 and 50 percent by weight of the initial total.

27. The fruit spread of claim 26, wherein the first quantity represents between 40 and 50 percent by weight of the initial total.

28. The fruit spread of claim 25, wherein:
the second quantity represents between 1 and 60 percent by weight of the initial total; and
the third quantity represents between 1 and 50 percent of the initial total.

29. The fruit spread of claim 28, wherein:
the second quantity represents between 5 and 25 percent by weight of the initial total; and
the third quantity represents between 30 and 50 percent by weight of the initial total.

30. The fruit spread of claim 16, wherein the particular fruit is one of strawberry, apricot, blueberry, grape, boysenberry, orange, blackberry, black raspberry, peach, pineapple, mango, guava, papaya, choke cherry, cherry, lemon, red currant, and black currant.

31. A fruit spread comprising:
first soluble solids from a particular fruit; and
second soluble solids from a concentrated juice of the particular fruit;
wherein the first and second soluble solids represent between 5 and 99 percent by weight of a total soluble solids of the fruit spread.

32. The fruit spread of claim 31, wherein the first and second soluble solids represent between 9 and 72 percent by weight of the fruit spread.

33. The fruit spread of claim 32, wherein:
the particular fruit has 10% or greater of soluble solids in a naturally occurring form; and
the first and second soluble solids represent between 11 and 68 percent by weight of the fruit spread.

34. The fruit spread of claim 33, wherein:
the particular fruit has 12% or greater of soluble solids in a naturally occurring form; and
the first and second soluble solids represent between 13 and 68 percent by weight of the fruit spread.

35. The fruit spread of claim 31, wherein the total soluble solids of the fruit spread represents between 15 and 72 percent by weight of the fruit spread.

36. The fruit spread of claim 35, wherein the total soluble solids of the fruit spread represents between 40 and 68 percent by weight of the fruit spread.

37. The fruit spread of claim 31, wherein the total soluble solids of the fruit spread represents greater than 24 percent by weight of the fruit spread.

38. The fruit spread of claim 31, wherein the fruit spread is pasteurized.

39. The fruit spread of claim 31, wherein the particular fruit is one of strawberry, apricot, blueberry, grape, boysenberry, orange, blackberry, black raspberry, peach, pineapple, mango, guava, papaya, choke cherry, cherry, lemon, red currant, and black currant.
